(19) United States
(12) Patent Application Publication
(10) Pub. No.: US 2008/0162852 A1
(43) Pub. Date: Jul. 3, 2008

(54) Tier-based memory read/write micro-command scheduler

(76) Inventors: Surya Kareenahalli, Folsom, CA (US); Zohar Bogin, Folsom, CA (US)

Correspondence Address: INTEL/BLAKELY, 1279 OAKMEAD PARKWAY, SUNNYVALE, CA, 94085-4040, US

(21) Appl. No.: 11/647,985

(22) Filed: Dec. 28, 2006

(51) Int. Cl. G06F 13/00

(52) U.S. Cl. 711/167

(57) ABSTRACT

A method, apparatus, and system are described. In one embodiment, the method comprises a chipset receiving a plurality of memory requests, wherein each memory request comprises one or more micro-commands that each require one or more memory clock cycles to execute, and scheduling the execution of each of the micro-commands from more than one of the plurality of memory requests in an order to reduce the number of total memory clock cycles required to complete execution of the more than one memory requests.

### FIELD OF THE INVENTION

The invention relates to the scheduling of memory read and write cycles.

### BACKGROUND OF THE INVENTION

Performance of a chipset is primarily defined by how the read and write cycles to memory are handled. Idle-leadoff latency, average latency, and overall bandwidth of read and write cycles are three general metrics which can define the performance of a chipset. There are three types of results which take place when a memory read or write (referred to as read/write below) takes place: a page hit, a page empty, and a page miss. A page hit result means that the row in the bank of memory with the request's target address is currently an active row. A page empty result happens when the row in the bank of memory with the request's target address is not currently active, but the row can be activated without deactivating any open row. Finally, a page miss result takes place when the row in the bank of memory with the request's target address is not currently active, and the row can only be activated after another currently active row is deactivated.

For example, in the case of a memory read, a page hit result requires only one micro-command, a read micro-command that reads the data at the target address in the row of memory. A page empty result requires two micro-commands. First, an activate micro-command is needed to activate the row of the given bank of memory with the requested data. Once the row is activated, the second micro-command, the read micro-command, is used to read the data at the target address in the row of memory. Finally, a page miss result requires three micro-commands: first a precharge micro-command is needed to deactivate a currently active row of memory from the same memory bank to make room for the row targeted by the page miss result. Once a row has been deactivated, then an activate micro-command is needed to activate the row of the given bank of memory with the requested data. Once the row is activated, the third micro-command, the read micro-command, is used to read the data at the target address in the row of memory. In general, a page hit result takes less time to execute than a page empty result, and a page empty result takes less time to execute than a page miss. Memory write requests have the same results and micro-commands as memory read micro-commands except the read micro-command is replaced with a write micro-command.

Standard policies for memory reads and writes require that each result (i.e. a page hit, a page empty, and a page miss) have all the micro-commands associated with the result executed in the order of the memory read/write. For example, if a page miss read request arrives to be executed at a first time and a page hit read request arrives immediately thereafter at a second time, the precharge-activate-read micro-commands associated with the page miss read request will be executed in that order first and then the read micro-command associated with the page hit read request will be executed following the execution of all three page miss micro-commands. This scheduling order creates an unwanted delay for the page hit read request.

Furthermore, for an individual memory read/write there is a delay between each micro-command because the memory devices take a finite amount of time to precharge a row before an activate command can be executed on a new row and the devices also take a finite amount of time to activate a row before a read/write command can be executed on that row. This delay depends on the hardware, but requires at least a few memory clock cycles between each micro-command.

### DESCRIPTION OF THE DRAWINGS

The present invention is illustrated by way of example and is not limited by the figures of the accompanying drawings, in which like references indicate similar elements, and in which:

FIG. 1 is a block diagram of a computer system which may be used with embodiments of the present invention.

FIG. 2 describes one embodiment of arbitration logic associated with the tier-based memory read/write micro-command scheduler.

FIG. 3 is a flow diagram of one embodiment of a process to schedule DRAM memory read/write micro-commands.

### DETAILED DESCRIPTION OF THE INVENTION

Embodiments of a method, apparatus, and system for a tier-based DRAM micro-command scheduler are described. In the following description, numerous specific details are set forth. However, it is understood that embodiments may be practiced without these specific details. In other instances, well-known elements, specifications, and protocols have not been discussed in detail in order to avoid obscuring the present invention.

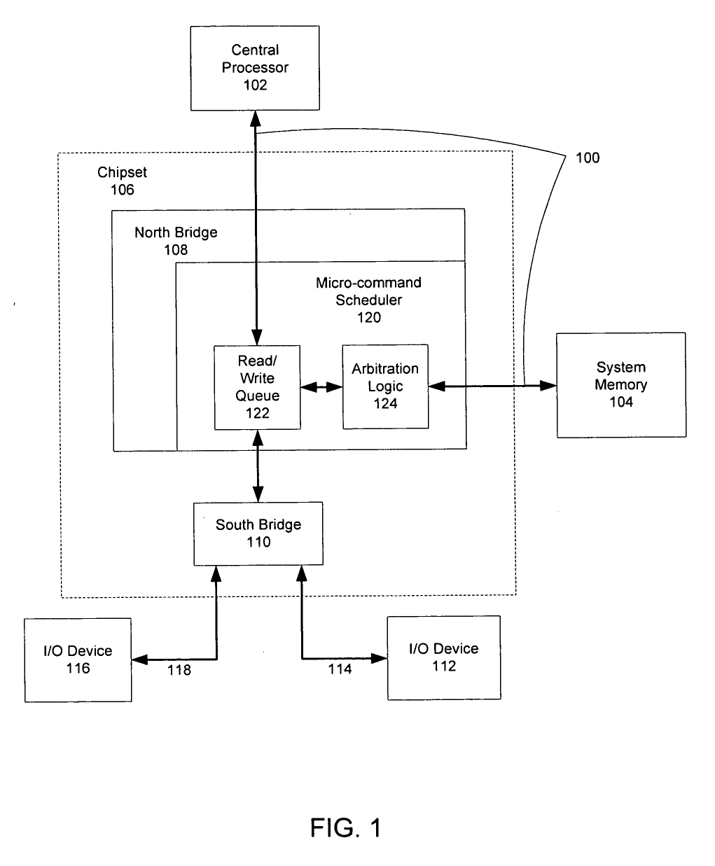

FIG. 1 is a block diagram of a computer system which may be used with embodiments of the present invention. The computer system comprises a processor-memory interconnect 100 for communication between different agents coupled to interconnect 100, such as processors, bridges, memory devices, etc. Processor-memory interconnect 100 includes specific interconnect lines that send arbitration, address, data, and control information (not shown). In one embodiment, central processor 102 may be coupled to processor-memory interconnect 100. In another embodiment, there may be multiple central processors coupled to processor-memory interconnect (multiple processors are not shown in this figure). In one embodiment, central processor 102 has a single core. In another embodiment, central processor 102 has multiple cores.

Processor-memory interconnect 100 provides the central processor 102 and other devices access to the system memory 104. In many embodiments, system memory is a form of dynamic random access memory (DRAM) including synchronous DRAM (SDRAM), double data rate (DDR) SDRAM, DDR2 SDRAM, Rambus DRAM (RDRAM), or any other type of DRAM memory. A system memory controller controls access to the system memory 104. In one embodiment, the system memory controller is located within the north bridge 108 of a chipset 106 that is coupled to processor-memory interconnect 100. In another embodiment, a system memory controller is located on the same chip as central processor 102. Information, instructions, and other data may be stored in system memory 104 for use by central processor 102 as well as many other potential devices. I/O devices, such as I/O devices 112 and 116, are coupled to the south bridge 110 of the chipset 106 through one or more I/O interconnects 114 and 118.

In one embodiment, a micro-command scheduler 120 is located within north bridge 108. In this embodiment, the micro-command scheduler 110 schedules all of the memory reads and writes associated with system memory 104. In one embodiment, the micro-command scheduler receives all memory read and write requests from requestors in the system including the central processor 102 and one or more bus master I/O devices coupled to the south bridge 110. Additionally, in one embodiment a graphics processor (not shown) coupled to north bridge 108 also sends memory read and write requests to the micro-command scheduler 120.

In one embodiment, the micro-command scheduler 120 has a read/write queue 122 that stores all the incoming memory read and write requests from system devices. The read/write queue may have differing numbers of entries in different embodiments. Furthermore, in one embodiment, arbitration logic 124 coupled to the read/write queue 122 determines the order of execution of the micro-commands associated with the read and write requests stored in the read/write queue 122.

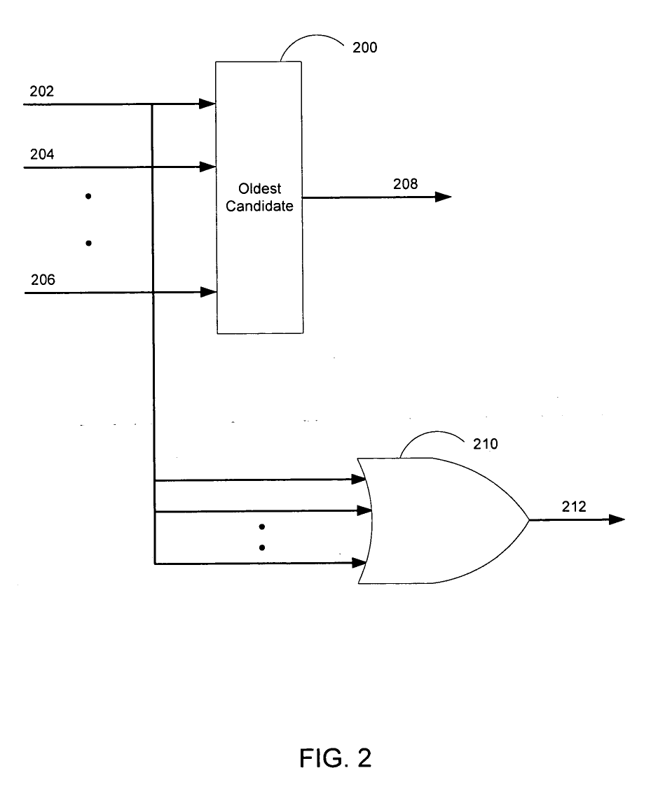

FIG. 2 describes one embodiment of arbitration logic associated with the tier-based memory read/write micro-command scheduler. In one embodiment, the arbitration logic shown in FIG. 2 comprises an arbitration unit for page hit result memory reads or writes. In this embodiment, an arbiter device 200 has a plurality of inputs that correspond to locations in the read/write queue (item 122 in FIG. 1). The inputs correspond to the number of entries in the read/write queue. Thus, in one embodiment input 202 is associated with queue location 1, input 204 is associated with queue location 2, and input 206 is associated with queue location N, where N equals the number of queue locations.

Each input includes information as to whether there is a valid page hit read/write request stored in the associated queue entry as well as whether the page hit request is safe. A safe entry is one in which, at the time of determination, the entry would be able to be scheduled immediately (just-in-time scheduling) on the interconnect to system memory without adverse consequences to any other entry in the queue. Thus, in one embodiment, the safety information (e.g. safe=1, not safe=0) as well as the determination that the entry is a page hit read/write request (e.g. page hit=1, non page hit=0) are logically AND'ed and if the result is a 1, then a safe page hit read/write request is present in the associated queue entry.

The arbiter device 200 receives this information for every queue location and then determines which of the available safe page hit entries is the oldest candidate (i.e. the request that arrived first for all of the safe page hit entries currently in the queue). Then, the arbiter device 200 outputs the queue entry location of the first arrived safe page hit request onto output 208. If no safe page hit request is available, the output will be zero.

In one embodiment, the input lines to OR gate 210 are coupled to every input into the arbiter device 200. Thus, output 212 will send out a notification that at least one input from input 1 to input N (202-206) is notifying the arbiter device 200 that a safe page hit read/write request exists in the queue.

In another embodiment, the arbitration logic shown in FIG. 2 comprises an arbitration unit for page empty result memory reads and writes. In this embodiment, an arbiter device 200 has a plurality of inputs that correspond to locations in the read/write queue (item 122 in FIG. 1.

Each input includes information as to whether there is a valid page empty read/write request stored in the associated queue entry as well as whether the page empty request is safe. As stated above, a safe entry is one in which, at the time of determination, the entry would be able to be scheduled immediately on the interconnect to system memory without adverse consequences to any other entry in the queue. Thus, in one embodiment, the safety information (e.g. safe=1, not safe=0) as well as the determination that the entry is a page empty read/write request (e.g. page empty=1, non page empty=0) are logically AND'ed and if the result is a 1, then a safe page empty read/write request is present in the associated queue entry.

The arbiter device 200 receives this information for every queue location and then determines which of the available safe page empty entries is the oldest candidate (i.e. the request that arrived first for all of the safe page empty entries currently in the queue). Then, the arbiter device 200 outputs the queue entry location of the first arrived safe page empty request onto output 208. If no safe page empty request is available, the output will be zero.

In one embodiment, the input lines to OR gate 210 are coupled to every input into the arbiter device 200. Thus, output 212 will send out a notification that at least one input from input 1 to input N (202-206) is notifying the arbiter device 200 that a safe page empty read/write request exists in the queue.

In another embodiment, the arbitration logic shown in FIG. 2 comprises an arbitration unit for page miss result memory reads or writes. In this embodiment, an arbiter device 200 has a plurality of inputs that correspond to locations in the read/write queue (item 122 in FIG. 1.

Each input includes information as to whether there is a valid page miss read/write request stored in the associated queue entry, whether the page miss request is safe, and whether there are any page hits in the read/write queue to the same bank as the page miss. If there is a same bank page hit request in the queue, the arbiter device 200 does not consider the page miss request because if the page miss request were to be executed, all page hit requests to the same bank would turn into page empty requests and cause significant memory page thrashing. Thus, a same bank page hit indicator would be inverted so if there was a same bank page hit the result would be a zero and if there was no same bank page hit request in the queue the result would be a one.

Furthermore, as stated above, a safe entry is one in which, at the time of determination, the entry would be able to be scheduled immediately on the interconnect to system memory without adverse consequences to any other entry in the queue. Thus, in one embodiment, the safety information (e.g. safe=1, not safe=0), the determination that the entry is a page miss read/write request (e.g. page miss=1, non page miss=0), and the same bank page hit indicator information (e.g. same bank page hit=0, no same bank page hit=1) are logically AND'ed and if the result is a 1, then a safe page empty read/write request is present in the associated queue entry.

The arbiter device 200 receives this information for every queue location and then determines which of the available safe page empty entries is the oldest candidate (i.e. the request that arrived first for all of the safe page empty entries currently in the queue). Then, the arbiter device 200 outputs the queue entry location of the first arrived safe page empty request onto output 208. If no safe page empty request is available, the output will be zero.

In one embodiment, the input lines to OR gate 210 are coupled to every input into the arbiter device 200. Thus, output 212 will send out a notification that at least one input from input 1 to input N (202-206) is notifying the arbiter device 200 that a safe page empty read/write request exists in the queue.

The output lines to all three embodiments of FIG. 2 (the page hit arbitration logic embodiment, page empty arbitration logic embodiment, and page miss arbitration logic embodiment) are entered into a cross-tier arbiter which utilizes the following algorithm:

1) if there is a safe page hit read/write request in the queue, the safe page hit read/write request wins,

2) else if there is a safe page empty read/write request in the queue, the safe page empty request wins,

3) else if there is a safe page miss read/write request in the queue, the safe page miss request wins

In one embodiment, the read/write requests in each entry are broken down into their individual micro-command sequences. Thus, a page miss entry would have precharge, activate, and read/write micro-commands in the entry location and when the cross-tier arbiter determines which command is executed, it determines this per micro-command. For example, if a page empty request is the first read/write request that arrives at an empty read queue, then the algorithm above will allow the page empty read/write request to begin execution. Thus, in this embodiment, the page empty read/write request is scheduled and the first micro-command (the activate micro-command) is executed. If a safe page hit read/write request arrives at that read queue on the next memory clock cycle, prior to the execution of the read/write micro-command for the page empty request, the algorithm above will prioritize and allow the page hit read request's read/write micro-command to be scheduled immediately, before the page empty read/write request's read/write micro-command. Thus, the page hit read/write request's read/write micro-command is scheduled to be executed on a memory clock cycle between the first page miss read/write request's activate micro-command and read/write micro-command.

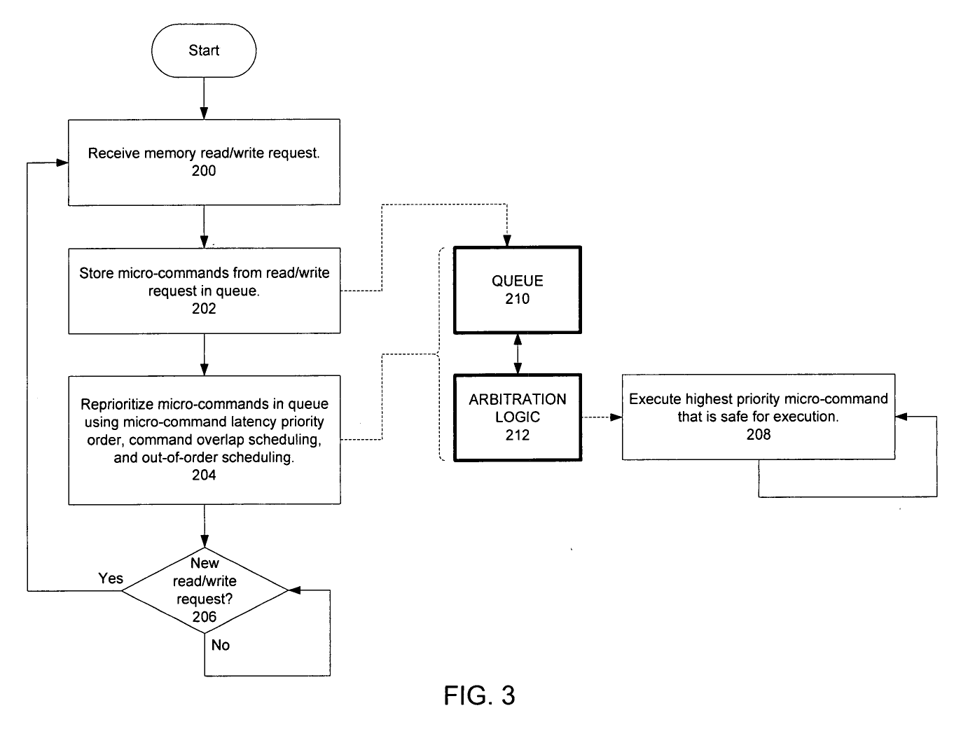

FIG. 3 is a flow diagram of one embodiment of a process to schedule DRAM memory read/write micro-commands. The process is performed by processing logic that may comprise hardware (circuitry, dedicated logic, etc.), software (such as is run on a general purpose computer system or a dedicated machine), or a combination of both. Referring to FIG. 7, the process begins by processing logic receiving a memory read/write request (processing block 200). The memory read/write request may be a page hit result, page empty result, or a page miss result. Next, processing logic stores each read/write request into a read/write queue. In one embodiment, each queue entry stores one or more micro-commands associated with the memory read/write request (processing block 202). A representation of the queue is shown in block 210 and processing logic that performs processing block 202 interacts with the queue 210 by storing received read/write requests into the queue 210.

Next, processing logic reprioritizes the micro-commands within the queue utilizing micro-command latency priorities (e.g. the latency for the micro-commands comprising a page miss request is greater than the latency for the micro-command comprising a page hit request) (processing block 204). Additionally, processing logic utilizes command overlap scheduling and out-of-order scheduling for prioritization of the read/write requests in the queue. In one embodiment, a page hit arbiter, page empty arbiter, page miss arbiter, and cross-tier arbiter (described in detail above in reference to FIG. 2) are utilized for the reprioritization processes performed in processing block 204. In one embodiment, processing logic comprises arbitration logic 212, and the process performed in processing block 204 includes the arbitration logic interacting with the queue 210.

Finally, processing logic determines whether there is a new read/write request that is ready to be received (processing block 206). In one embodiment, if there is not a new read/write request, then processing logic continues to poll for a new read/write request until one appears. Otherwise, if there is a new read/write request, processing logic returns to processing block 200 to start the process over again.

This process involves receiving read/write requests into the queue and reprioritizing the queue based on a series of arbitration logic processes. Additionally, processing logic continues to execute the highest priority micro-command safe for execution simultaneously per memory clock cycle. This allows the throughput of the memory interconnect to remain optimized by executing memory read/write micro-commands at every possible memory clock cycle.

In one embodiment, the cross-tier arbiter has a fail-safe mechanism that puts in place a maximum number of memory clock cycles that are allowed to pass before a lower priority read/write request is forced to the top of the priority list. For example, if a page miss request continues to be reprioritized by page hit after page hit, the page miss request may be indefinitely delayed if the fail-safe mechanism is not put in place in the cross-tier arbiter. In one embodiment, the number of clock cycles allowed before the cross-tier arbiter forces a lower priority read/write request to the top of the list is predetermined and set into the arbitration logic. In another embodiment, this value is set in the basic input/output system (BIOS) and can be modified during system initialization.

Thus, embodiments of a method, apparatus, and system for a tier-based DRAM micro-command scheduler are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
a device receiving a plurality of memory requests, wherein each memory request comprises one or more micro-commands that each require one or more memory clock cycles to execute; and
scheduling the execution of each of the micro-commands from more than one of the plurality of memory requests in an order to reduce the number of total memory clock cycles required to complete execution of the more than one memory requests.

2. The method of claim 1, wherein each of the plurality of memory requests are one of a memory read request and a memory write request.

3. The method of claim 2, further comprising overlapping the scheduling of micro-commands of more than one memory request.

4. The method of claim 3, wherein overlapping the scheduling of micro-commands further comprises inserting at least one micro-command of a first request between two separate micro-commands of a second request.

5. The method of claim 1, further comprising scheduling the completion of more than one request out of the order in which the more than one request was received by the device.

6. The method of claim 5, wherein scheduling the completion of more than one request out of order further comprises scheduling the final completing micro-command of a first request that arrives at the chipset at a first time after at least the final completing micro-command of a second request that arrives at the device at a second time later than the first time.

7. The method of claim 1, wherein scheduling the execution of each of the micro-commands is completed in a just-in-time manner.

8. The method of claim 7, wherein a just-in-time manner further comprises considering only those micro-commands that are ready to be executed and are safe to be executed.

9. The method of claim 1, wherein a result of each received request is selected from a group consisting of a page hit result, a page empty result, and a page miss result.

10. The method of claim 9, further comprising scheduling a page hit request if one is available in the queue, or scheduling a page empty request if one is available in the queue and no page hit request is available in the queue, or scheduling a page miss request if one is available in the queue and no page hit request or page empty request is available in the queue.

11. The method of claim 10, further comprising scheduling two requests in the order of their arrival if they both have the same page hit, page empty, or page miss result.

12. The method of claim 10, further comprising scheduling any request that has waited in the queue for a predetermined number of memory clock cycles regardless of the result if the request is safe.

13. An apparatus, comprising:
a queue to store a plurality of memory requests, wherein each memory request comprises one or more micro-commands that each require one or more memory clock cycles to execute; and
one or more arbiters to schedule the execution of each of the micro-commands from more than one of the plurality of memory requests in an order to reduce the number of total memory clock cycles required to complete execution of the more than one memory requests.

14. The method of claim 13, wherein each of the plurality of memory requests are one of a memory read request and a memory write request.

15. The apparatus of claim 14, wherein a result of each received request is selected from a group consisting of a page hit result, a page empty result, and a page miss result.

16. The apparatus of claim 15, further comprising the one or more arbiters to schedule a page hit request if one is available in the queue, or to schedule a page empty request if one is available in the queue and no page hit request is available in the queue, or to schedule a page miss request if one is available in the queue and no page hit request or page empty request is available in the queue.

17. The apparatus of claim 16, further comprising:
a page hit arbiter to schedule the execution order of any page hit requests;
a page empty arbiter to schedule the execution order of any page empty requests;
a page miss arbiter to schedule the execution order of any page miss requests;
and a cross-tier arbiter to schedule the final execution order of the requests from the page hit arbiter, the page empty arbiter, and the page miss arbiter.

18. The apparatus of claim 17, further comprising the page miss arbiter only scheduling a page miss request for execution if there are no outstanding page hit requests to the same memory bank as the page miss request.

19. A system, comprising:
a bus;
a first processor coupled to the bus;
a second processor coupled to the bus;
memory coupled to the bus;
a chipset coupled to the bus, the chipset comprising:
a queue to store a plurality of memory requests, wherein each memory request comprises one or more micro-commands that each require one or more memory clock cycles to execute; and
one or more arbiters to schedule the execution of each of the micro-commands from more than one of the plurality of memory requests in an order to reduce the number of total memory clock cycles required to complete execution of the more than one memory requests.

20. The method of claim 19, wherein each of the plurality of memory requests are one of a memory read request and a memory write request.

21. The apparatus of claim 20, wherein a result of each received request is selected from a group consisting of a page hit result, a page empty result, and a page miss result.

22. The apparatus of claim 21, further comprising the one or more arbiters to schedule a page hit request if one is available in the queue, or to schedule a page empty request if one is available in the queue and no page hit request is available in the queue, or to schedule a page miss request if one is available in the queue and no page hit request or page empty request is available in the queue.

23. The apparatus of claim 22, further comprising:
a page hit arbiter to schedule the execution order of any page hit requests;
a page empty arbiter to schedule the execution order of any page empty requests;
a page miss arbiter to schedule the execution order of any page miss requests;
and a cross-tier arbiter to schedule the final execution order of the requests from the page hit arbiter, the page empty arbiter, and the page miss arbiter.
